(19) United States
(12) Patent Application Publication
(10) Pub. No.: US 2005/0058335 A1
(43) Pub. Date: Mar. 17, 2005

(54) Defect management method

(76) Inventors: Chin Hsiang Lin, Shanghai (CN); Hong Jiang, Shanghai (CN); Jia Jie Yin, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 10/918,440

(22) Filed: Aug. 16, 2004

(30) Foreign Application Priority Data
Aug. 27, 2003 (CN) 03150606.2

(51) Int. Cl. G06K 9/00

(52) U.S. Cl. 382/141; 700/110; 700/121

(57) ABSTRACT

A method of defect management, comprising performing tool matching inspection within a defect management system and at least including scanning a produced wafer; checking a user level within the defect management system and the defect management system distributes resources of the defect management system according to the user level. An analyzing procedure template is edited and the defect management system executes an analyzing procedure according to the analyzing procedure template. Defect data is pre-filtered according to at least one basis and the basis is selected from the group of following terms: unclassified/classified, defect class, defect size, image type, defect pattern, and combining with CP data. A result report is output, wherein the result report combines the analysis procedure template with defect data.

### FIELD OF THE INVENTION

The present invention relates to a method of defect management system and, in particular, to a method of defect management system applied to manufacture wafers.

### DESCRIPTION OF THE PRIOR ART

As manufacturing techniques of semiconductor wafers progresses, the growing speed of increasingly complicated equipment, improvements in photographing ability, analyzing ability, and data storing capacity are exceeding the ability of traditional analyzing methods. As a result wafer defect management is beset with many problems.

Wafer inspection and failure analysis tools nowadays provide qualification and quantification information of defects and failures concerning manufacturing processes. However, an automatic system capable of connecting all of the wafer defect analyzing equipment is required because of the problems related to wafer defect management. This allows engineers to be capable of readily dealing with the more and more complex problems of wafer defects.

Furthermore, traditional defect management systems still have many problems which haven't been solved for a long while. For example, in the case of a defect management system, the modified data of manufacturing process tools should be taken into concern automatically for making correct responses about defects as well as status and reason. Next, analysis engineers have difficulty in analyzing or tracing since they cannot control the data of a particular tool or a particular classification effectively because the data of different tools collected or inspected is simplified into too few classifications. Moreover, in fixed analysis operating procedures and particular products, how to allow the analysis engineers to determine the analysis operating procedure themselves and understand the analysis operating procedure, has yet to be resolved. Moreover, one of the problems to be solved when many analysis engineers log into the defect management system simultaneously, is that the working speed becomes seriously slow.

### SUMMARY OF THE INVENTION

Accordingly, an object of the present invention is to provide a method of defect management that utilizes levels to distribute resources of the defect management system. It prioritizes the users in order to deal with the urgent status according to the levels.

Another object of the present invention is to provide a method of defect management that renders self-determined analyzing procedures and stores templates for monitoring and future use in the manner of flow charts.

Another object of the present invention is to provide a method of defect management that provides a pre-filtering step for accelerating the speed of users classifying data.

A further object of the present invention is to provide a method of defect management that generates a result report by combining the analysis procedure template and defect data.

To achieve above objects, the present invention provides a method of defect management, comprising tool matching inspection within a defect management system, comprising scanning a produced wafer; checking a user level within the defect management system. The defect management system distributes resources of the defect management system according to the user level. The method further comprises editing an analyzing procedure template and the defect management system executes an analyzing procedure according to the analyzing procedure template. Defect data is pre-filtered according to at least one basis and the basis is selected from one group of combining the following terms: unclassified/classified, defect class, defect size, image type, defect pattern, and combining with circuit probing (CP) data. A result report is output, wherein the result report combines the analysis procedure template and defect data.

The various objects and advantages of the present invention will be more readily understood from the following detailed description when read in conjunction with the appended drawings.

### BRIEF DESCRIPTION OF THE DRAWINGS

FIG. 1 is a flowchart of a method of defect management according to an embodiment of the present invention; and

FIG. 2 is a flowchart of an editing analyzing procedure according to an embodiment of the present invention.

### DESCRIPTION OF THE PREFERRED EMBODIMENTS

The method of defect analysis management of the present invention is applied broadly to many ways of defect analysis management. People familiar the field should understand that such variations are not to be regarded as a departure from the spirit and scope of the present invention in the examples of preferred embodiments describing the method of the present invention.

Also, the schematic view of the present invention is described in detail as follows. The indicated method of the flowcharts does not make any limited cognition in the described embodiments of the present invention.

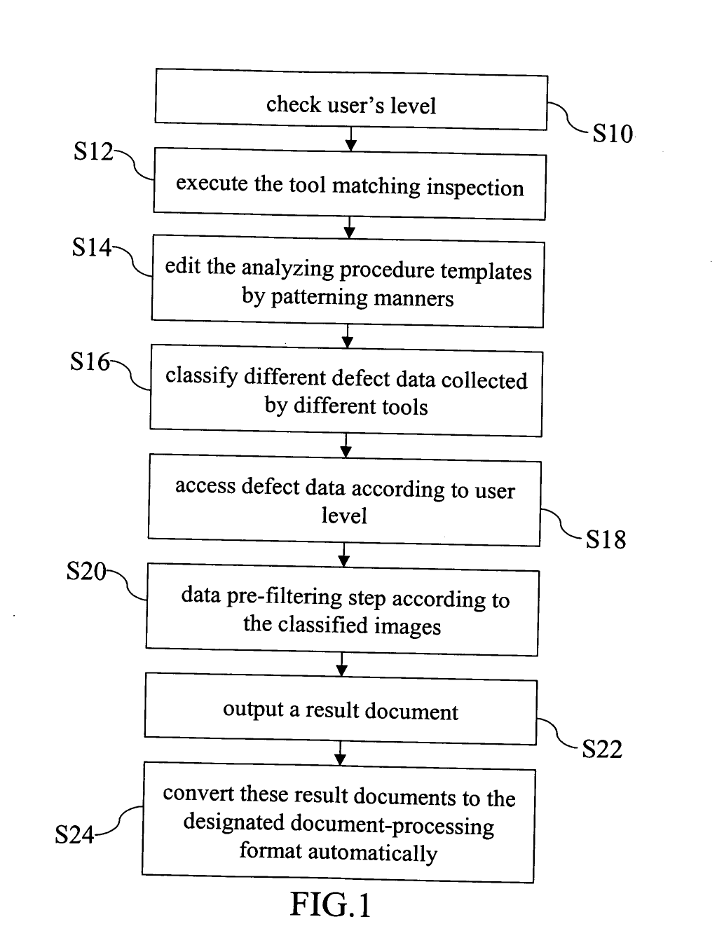

FIG. 1 is a flowchart of a method of defect management of the present invention. Every step has been described which can be executed individually but not limited by the sequence in FIG. 1 and the step sequence of the flowchart in FIG. 1 can be changed arbitrarily.

In the present embodiment, the defect management system will check a user's user level (step 10) to determine the user's priority sequence and authority scope in using the defect management system. The number or user levels is not limited and has at least two levels. When a higher priority user want to log into the defect management system when the number of users reaches full, the defect management system will replace the lower level user with a higher level user by checking the user levels. Moreover, users with higher user levels can make the system suspend executing commands or instructions for users with lower user levels in order to maintain or improve the executing speed of the defect management system. One advantage of the present invention is to use system resources and improve the executing speed of the system by logging in with higher user levels when urgently using the resources of the defect management system.

Next, it executes the tool matching inspection (step 12) for the defect management system of the present invention. By manufacturing wafers on the same tool or on a plurality tools with the same function, scanning many times and comparing the results document, the tool matching inspection can be completed. The advantage of using manufacturing wafers makes the inspection results in response to actual status of the tools more reliable. Moreover, comparisons of matching inspections can be expanded to different type tools for indicating differences between different but similar tools. The defect management system may also carry on these matching inspections of overlapping calculation and analysis. Also, a scanned document renders the different comparisons between the tools faster and more convenient. Moreover, the capture rate of the tool matching inspection is obtained more accurately by comparing the overlap of defect schematic views of the defect management system.

Next, users can edit the analyzing procedure templates by patterning manners (step 14). Then, the defect management system can classify different defect data collected by different tools according to the template used in the defect analyzing procedure (step 16). These are classified into 6 types according to the equipment group when the present invention carried out collecting data. Therefore, there are 6 types of collected image data and are different from the general two types (optical microscope (OM) re-checking images and scanning electron microscope (SEM) re-checking images). The 6 types of images of the present invention includes: KLA re-checking images, for carrying on re-checking generated images of the original position on the KLA tool; AIT re-checking images, for carrying on re-checking generated images of the original position on the AIT tool; OM re-checking images, for re-checking images generated on the OM tool; single SEM image, which is an image generated on the SEM tool; spectral SEM images, which are images generated on the SEM tool and spectral images generated on the EDS; and FIB images, which are images generated on the FIB re-checking tool. The defect management system can distinguish the two types of images, single SEM image and spectral SEM images, according to the features provided by the SEM tool.

Additionally, the present invention can access defect data according to the user levels (step 18). In the present invention, unimportant data wasting resources of the system are avoided by limiting the amount of accessing any class defect images.

The defect management system authorizes users to delete or replace the stored images in order to preventing important images from being deleted, replaced, or covered by the new images according to the higher or lower user level when the amount of a certain class images reaches full capacity.

Moreover, the defect management system carries out data pre-filtering (step 20) according to the classified images of the present invention when users desire to query the defect data. Corresponding data is found immediately and the image data can also be sequenced according to the classification in order to improve the speed of querying data by utilizing the classified images of the present invention. Additionally, the pre-filtering step of the present invention can also be carried out according to other conditions: unclassified/classified defect, defect class, defect size, image type, defect pattern and combined with CP data.

Next, the defect management system outputs a result document according to users' requirements (step 22). The output result documents of the defect management system are charts, maps, images or spreadsheets, etc. The present invention converts these result documents to a designated document-processing format automatically (step 24). The designated document-processing format here can be document-processing tools used in general personal computers, for example, WORD, EXCEL, POWERPOINT, OFFICE TOOLS, etc. Also, the present invention can combine the analyzing procedure templates which users edit themselves with the result documents automatically for forming a whole report.

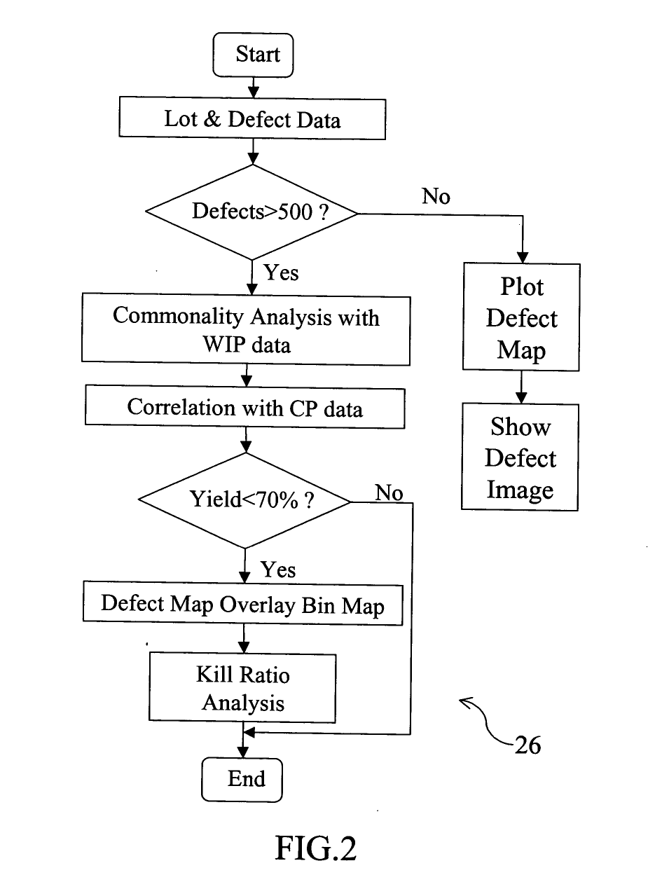

FIG. 2 is a flowchart of an analyzing procedure of the present invention. The template 26 is shown on the screen, wherein the flowchart is an analyzing procedure edited according to users' requirements. Using the patterning manner for editing analysis steps executed by the defect management system in order to provide user type analyzing procedures and utilizing template manners to be stored instantaneously and can be repeatedly used which saves users' operating editing time.

Therefore, a method of defect management of the present invention comprises tool matching inspection within a defect management system and at least including scanning a produced wafer; checking a user level within the defect management system and the defect management system distributes resources of the defect management system according to the using level; editing an analyzing procedure template and executing an analyzing procedure according to the analyzing procedure template; classifying plurality defect data according to a plurality of classified images and the classified images at least comprising KLA re-checking images, ATI re-checking images, OM re-checking images, single SEM image, spectral SEM images, and FIB images; accessing data according to the user levels; and outputting a result report, wherein the result report combines the analysis procedure template with defect data.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

1. A method of defect management comprising:
executing tool matching inspection within a defect management system comprising scanning a produced wafer;
checking a user level within the defect management system, wherein the defect management system distributes resources of the defect management system according to the user level;
editing an analyzing procedure template, wherein the defect management system executes an analyzing procedure according to the analyzing procedure template;
pre-filtering a plurality of defect data, wherein the pre-filtering is based on at least one basis of unclassified/classified, defect class, defect size, image type, defect pattern, or a combination of these; and
outputting a result report, wherein the result report combines the analysis procedure template with defect data.

2. The method according to claim 1, further comprising accessing, deleting or replacing the plurality of defect data according to the user level.

3. The method according to claim 1, further comprising classifying the plurality of defect data according to a plurality of classified images comprising KLA re-checking images, ATI re-checking images, OM re-checking images, single SEM image, spectral SEM images, and FIB images.

4. A method of defect management comprising:
performing a tool matching inspection within a defect management system, comprising scanning a produced wafer;
checking a user level within the defect management system, wherein the defect management system distributes resources of the defect management system according to the user level;
editing an analyzing procedure template, wherein the defect management system executes an analyzing procedure according to the analyzing procedure template;
classifying a plurality of defect data according to a plurality of classified images, wherein the plurality of classified images comprises KLA re-checking images, ATI re-checking images, OM re-checking images, single SEM image, spectral SEM images, FIB images, or a combination of these;
accessing data according to the user levels; and
outputting a result report, wherein the result report combines the analysis procedure template with defect data.

5. The method according to claim 4, further comprising pre-filtering the plurality of defect data, wherein the pre-filtering step is based on at least one basis selected from a group of combining with following terms: unclassified/classified defect, defect class, defect size, image type, defect pattern and combining with circuit probing (CP) data.

6. The method according to claim 4, further comprising accessing, deleting or replacing the plurality of defect data according to the user level.

7. The method according to claim 4, wherein the analyzing procedure template is shown as a flowchart.

8. A method of defect management comprising:
checking a user level within a defect management system, wherein the defect management system distributes resources of the defect management system according to the user level;
carrying out a tool matching inspection within the defect management system comprising scanning a produced wafer;
editing an analyzing procedure template, wherein the defect management system executes an analyzing procedure according to the analyzing procedure template;
classifying a plurality of defect data according to a plurality of classified images, the plurality of classified images comprising KLA re-checking images, ATI re-checking images, OM re-checking images, single SEM image, spectral SEM images, and FIB images;
pre-filtering a plurality of defect data based on, unclassified/classified, defect class, defect size, image type, defect pattern, or a combination of these; and
outputting a result report, wherein the result report combines the analysis procedure template with defect data.

9. The method according to claim 8, further comprising accessing, deleting or replacing the plurality of defect data according to the user level.

10. The method according to claim 8, wherein the analyzing procedure template is shown as a flowchart.
